(19) United States
(12) Patent Application Publication
(10) Pub. No.: US 2011/0143824 A1
(43) Pub. Date: Jun. 16, 2011

(54) APPARATUS COMPRISING A JOINING PART

(75) Inventor: Aki Laine, Santa Monica, CA (US)

(73) Assignee: NOKIA CORPORATION, Espoo (FI)

(21) Appl. No.: 12/637,276

(22) Filed: Dec. 14, 2009

(51) Int. Cl. H04M 1/00

(52) U.S. Cl. 455/575.4

(57) ABSTRACT

An apparatus including a first part having a keyboard, a second part having a display, and a joining part linking the first part with the second part. The joining part is configured to allow sliding of the second part in relation to the first part from a closed configuration to a first open configuration revealing the keyboard. The joining part is further configured to allow tilting of the second part in relation to the first part from the closed configuration to a second open configuration for media consumption or sharing.

### TECHNICAL FIELD

The present invention relates to apparatuses comprising a joining part configured to join together a first part with a second part.

### BACKGROUND ART

Currently, the mobile communication devices in the market often contain a closed configuration and an open configuration. In the closed configuration, typically a planar base part of the device and a planar top part of the device are completely against each other. To enter the open configuration, the top part is slid aside so that an entire keyboard located in the base part is revealed for use. When the user for example desires to consume or share media, such as watch TV from a top display of the top part, the user may hold the device in his/her hands to maintain a convenient viewing angle.

In certain other communication devices, the open configuration is entered by pushing the top part away from the user such that the top part slides forward over the base part and then raises and locks itself behind the keyboard into a fixed angled position supported by arms. When the user for example desires to consume or share media, such as watch TV, the user may use the device at a viewing angle fixed by the fixed angled position.

### SUMMARY

According to a first example aspect of the invention there is provided an apparatus comprising:

a first part;
a second part; and
a joining part configured to join together the first part with the second part, wherein the joining part is configured to allow:
(i) sliding of the second part in relation to the first part from a closed configuration to a first open configuration, and
(ii) tilting of the second part in relation to the first part from the closed configuration to a second open configuration.

The term configuration in the expression closed configuration may mean a closed position. Similarly, the open configurations may mean open or opened positions of the apparatus. The first open position may be the end position of the slide.

The joining part may be a mechanical part or an assembly of interlinked mechanical parts. Accordingly, the joining part may be formed by one part or a combination of parts. The joining part may physically join together the first part and the second part. The joining part may be configured to keep the first part and the second part joined together and to allow the sliding and tilting movement.

In certain example embodiments, the first part has a first user interface element which is revealed upon sliding the second part in relation to the first part from the closed configuration to the first open configuration. The first user interface element may be a user input element. It may be a keyboard. Alternatively, it may be for example a touch sensitive display.

In certain example embodiments, the second part has a display. The display may be for example a touch sensitive display.

Certain example embodiments provide a side slide mechanism which combines a side slide functionality with a kick stand functionality. When the kick stand (or tilting) mechanism is integrated to the side slide mechanism there no need to have it in another place of the product.

In certain example embodiments, three different (separate) modes of the product are provided: open, closed and tilted. This provides the user with more possibilities to interact with the product, it offers more from which to choose from. In certain example embodiments, the user may tilt up the top part (or second part) for the media consumption or sharing purposes without having to slide the top part open first. In certain example embodiments, when the top part is tilted, a qwerty keypad (or an ITU-T or corresponding keypad) is not visible to the user (from the front side of the product). When the user wants to access the qwerty keypad he/she may push the top part down and slide it open so that the keypad is revealed.

In certain example embodiments, the tilting angle is adjustable by the user. The user may lift the top part from the back end (or back edge) of the top part so that the top part is tilted into the angle he/she wishes without the top part being automatically locked into a fixed angle. This way the user is in control. In certain example embodiments, the device opens like a book so that folding (the folding parts being separate parts linked by the joining part) occurs at the front end (or front edge) of the device. When for example watching TV, viewing movies or internet content on a top display, it is easy to adjust a good viewing angle when one does not have to slide the top part or lid (second part) first away from the base part (first part), but one may just lift the lid from the back edge of the lid into a desired angle.

In certain example embodiments, the joining part may have a hinge mechanism with hinge rotating function and a slide mechanism with side slide function. The apparatus has a closed state, a slide open state in which state a full qwerty keyboard is exposed, and a tilt up state for media consumption or sharing. Thus, the top part of the apparatus may have an angled media consumption mode and a separate slide open qwerty mode.

In certain example embodiments, the first part and the second part are completely against each other (or face each other) in the closed configuration, partly against each other in the first open configuration and in an angled position against each other in the second open configuration.

In certain example embodiments, the joining part is configured to allow:
tilting up the second part without having to slide the second part in relation to the first part first.

In certain example embodiments, the apparatus is configured to allow lifting the second part from a back end of the second part wherein the second part rotates around a rotation axis substantially formed by its front end.

In certain example embodiments, the tilting into the second open configuration occurs by the second part tilting and the front end of the second part substantially keeping its lateral location in the same place as it was in the closed configuration.

In certain example embodiments, the joining part is configured to provide a side slide function for the apparatus, and separately, tilting up function via jointed movement of the second part. The jointed movement may comprise rotating movement around a rotation axis defined by a joint, such as a hinge.

In certain example embodiments, the joining part comprises a hinge mechanism allowing rotation of the second part. In certain example embodiments, the hinge mechanism comprises a friction hinge. In certain example embodiments, the joining part comprising the hinge mechanism is configured to slide in a groove comprised by the first part.

In certain example embodiments, the first part and second part both are substantially planar parts. In certain example embodiments, the second part comprises a display. It may be a top display visible to the user in each of the closed and open configurations (or positions of the apparatus). In certain example embodiments, the second part comprises the display on the outer surface of the second part.

In certain example embodiments, the apparatus is configured to open like a book from the closed configuration to the second open configuration. and wherein the movement from the closed configuration to the first open configuration is substantially a planar movement.

In certain example embodiments, the tilting angle into which the second part settles is adjustable to the user. In other words, in the event the second part comprises a display, the apparatus is configured for adjustment of the viewing angle of the display by the user. The apparatus may comprise a limiter limiting the maximum tilting angle.

In certain example embodiments, the positions from which the second part can be tilted are controlled.

In certain example embodiments, the apparatus is provided with a control mechanism configured to prevent tilting of the second part in relation to the first part from other positions than the closed configuration.

In certain example embodiments, the apparatus is provided with a control mechanism configured to allow:

(iii) tilting of the second part in relation to the first part from the first open configuration to a third open configuration, and wherein the control mechanism is configured to prevent:
(iv) tilting of the second part in relation to the first part from other positions than the closed configuration and the first open configuration.

The apparatus may be an electrical device. It may be a mobile handheld communication device, such as a mobile terminal, mobile communicator, a PDA device, a mobile phone, or similar. It may be a laptop computer or a smaller computing device.

According to a second example aspect of the invention there is provided an apparatus comprising:

a first part;
a second part; and
means for joining together the first part with the second part, wherein said means are configured to allow:
(i) sliding of the second part in relation to the first part from a closed configuration to a first open configuration, and
(ii) tilting of the second part in relation to the first part from the closed configuration to a second open configuration.

According to a third example aspect of the invention there is provided a joining part, or an apparatus comprising a joining part, configured to join together a first part and a second part of a device, wherein the joining part is configured to allow:

(i) sliding of the second part in relation to the first part from a closed configuration to a first open configuration, and
(ii) tilting of the second part in relation to the first part from the closed configuration to a second open configuration.

Different non-binding example aspects and embodiments of the present invention have been illustrated in the foregoing. The above embodiments are used merely to explain selected aspects or steps that may be utilized in implementations of the present invention. Some embodiments may be presented only with reference to certain example aspects of the invention. It should be appreciated that corresponding embodiments may apply to other example aspects as well.

### BRIEF DESCRIPTION OF THE DRAWINGS

The invention will be described, by way of example only, with reference to the accompanying drawings, in which:

FIG. 1 shows a schematic drawing of an apparatus in a closed configuration according to an example embodiment;

FIG. 2 shows a schematic drawing of an apparatus in a first open configuration according to an example embodiment;

FIG. 3 shows a schematic drawing of an apparatus in a second open configuration according to an example embodiment;

FIG. 4 shows an example of an exploded view of the apparatus of FIGS. 1-3;

FIG. 5 shows an example of a cross-sectional view of the apparatus of FIG. 4;

FIG. 6 shows another schematic drawing of an apparatus in a closed configuration according to an example embodiment;

FIG. 7 shows a specific detail of the apparatus of FIG. 6;

FIG. 8 shows another schematic drawing of an apparatus in a first open configuration according to an example embodiment;

FIG. 9 shows another schematic drawing of an apparatus in a second open configuration according to an example embodiment;

FIG. 10 shows an apparatus according to another example embodiment;

FIG. 11 shows the apparatus of FIG. 10 from a different projection;

FIG. 12 shows the apparatus of FIG. 10 in a slide position;

FIG. 13 shows an example of a cross-sectional view of the apparatus of FIG. 10 in a closed configuration according to an example embodiment;

FIG. 14 shows an example of a cross-sectional view of the apparatus of FIG. 10 in a mid-slide position; and

FIG. 15 shows an example of a cross-sectional view of the apparatus of FIG. 10 in a third open configuration according to an example embodiment.

### DETAILED DESCRIPTION

In the following description, like numbers denote like elements.

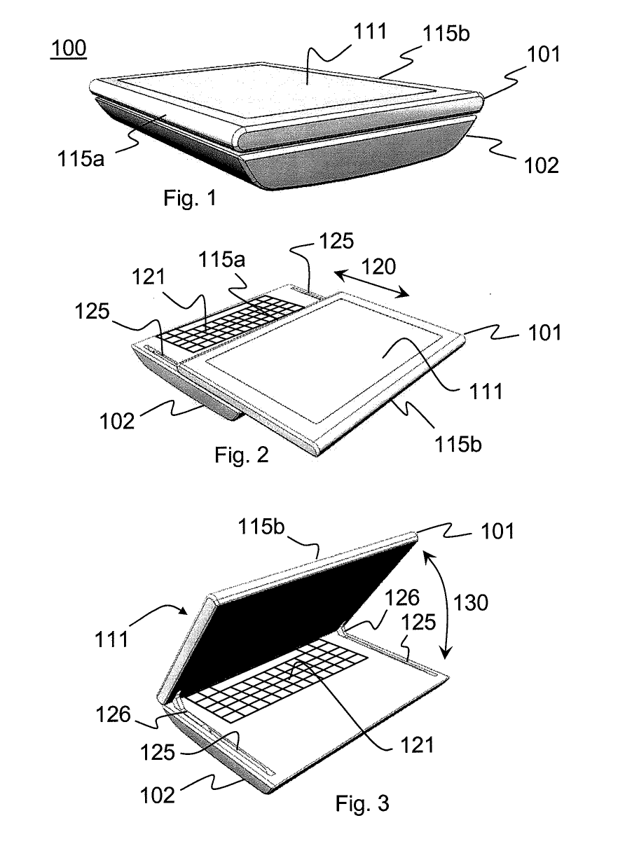

FIG. 1 shows a schematic drawing of an apparatus in a closed configuration according to an example embodiment. The apparatus 100 may be a mobile handheld communication device, an electrical device, such as a mobile terminal, mobile communicator, a PDA device, a small computer, a mobile phone, or similar.

The apparatus 100 comprises a top part or lid part 101 and a body part 102 attached to each other with a joining part or linker mechanism (not shown in FIG. 1). The apparatus is in the most compact form in the closed configuration. In this example, the top part 101 and the body part 102 are completely against each other. The top part 101 has a front end or edge 115a and a back end or edge 115b as shown in FIG. 1. The front end 115a is closer to the user in a typical use scenario of the apparatus. The top part 101 further comprises a top display 111, which may be a large display extending over the majority of the top surface of the top part 101. The display 111 may be a touch sensitive display, and the apparatus 100 may be operable with the aid of the touch sensitive display in the closed configuration. The body part 102 comprises a keypad (or keyboard) which is hidden (non-operable) in the closed configuration.

FIG. 2 shows a schematic drawing of the apparatus 100 in a first open configuration (which may also be denoted as slide open or qwerty mode) according to an example embodiment. The apparatus 100 may be slid from the closed configuration to the first open configuration and back from the first open configuration to the closed configuration in the planar direction as depicted by arrow 120. The joining part (not shown in FIG. 2), which may by attached to the top part 101 for example by a hinge mechanism (not shown in FIG. 2), guides the sliding movement. It slides in the groove 125 of the base part 102 when the top part 101 is slid in relation to the base part 102.

In the first open configuration, a full keypad 121, such as a qwerty keypad, is revealed for use for the user. The orientation of the keypad 121 is such that it may be most conveniently used from the direction in which it is closer to the user.

FIG. 3 shows a schematic drawing of an apparatus in a second open configuration (which may also be denoted as tilted mode) according to an example embodiment. The apparatus 100 may be moved from the closed configuration to the second open configuration and back from the second open configuration to the closed configuration in the direction as depicted by arrow 130 by lifting or lowering the top part 101 from the back end 115b of the part 101. The joining part 126 stays in the front end of the groove 125, and the apparatus 100 opens like a book. In this example embodiment, the joining part 126 comprises a hinge mechanism (inside the top part 101 in FIG. 3) at one end of the joining part 126 which allows rotational movement of the top part 101 while the other end of the joining part 126 remains in the groove 125. The hinge mechanism may comprise a friction hinge causing the top part 101 to stay in the exact angular position into which the user has tilted it, thus allowing a user adjustable viewing angle to the display 111 in the second open configuration (alternatively another arrangement may be used). The user located behind the top part 101 can use the display 111 for media consumption and sharing, such as watching TV, or viewing movies or internet content from a desired viewing angle. The keypad 121 is neither disturbing nor visible from the viewing direction. Depending on the implementation, the keypad 121 or part of it may be operable or non-operable in the tilted mode.

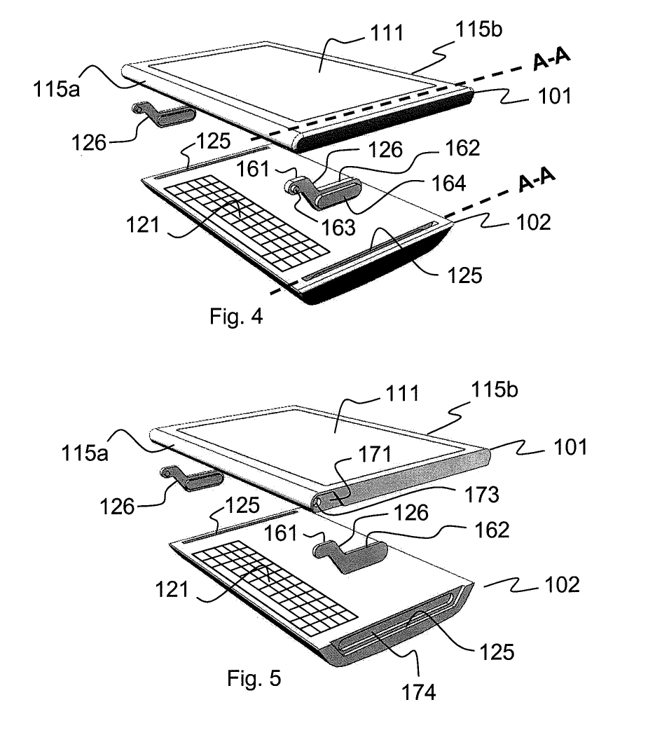

FIG. 4 shows an example of an exploded view of the apparatus 100, especially the joining part 126. In an example embodiment, the joining part is a part having a head section 161 at one end and a body section 162 at another end connected by a neck. The head section 161 comprises the hinge mechanism 163, such as a friction hinge, in one or both sides of the head section 161 depending on the implementation and the body section 162 comprises a protruding section 164 in one or both sides of the body section 162 whose function will become apparent in FIG. 5 showing a cross-sectional view at the A-A line in FIG. 4.

As shown in FIG. 5, the top part 101 comprises a recess 171 that corresponds to the head section 161 of the joining part 126. The form of the recess 171 locks the joining part 126 to the top part 101. In the recess 171 the top part 101 defines a corresponding aperture or hole 173 to which the hinge mechanism 163 (or a pin of the hinge mechanism) fits. The hinge mechanism allows jointed (or rotating) movement of the top part 101 enabling the tilting of the top part 101 into the second open position when the joining part 126 is in the front end of the groove 125. The groove 125, in turn, comprises an additional recess 174 which corresponds in its sizing to the protruding section 164 of the body section 162 such that when the body section 162 of the joining part 126 generally travels in the groove 125 the protruding section 164 fits to travel (according to the sliding movement of the top part 101) back and forth in the recess 174 guiding the sliding movement of the top part 101. At the same time the protruding section 164 in the recess 174 prevents the joining part 126 from getting out of the groove 125.

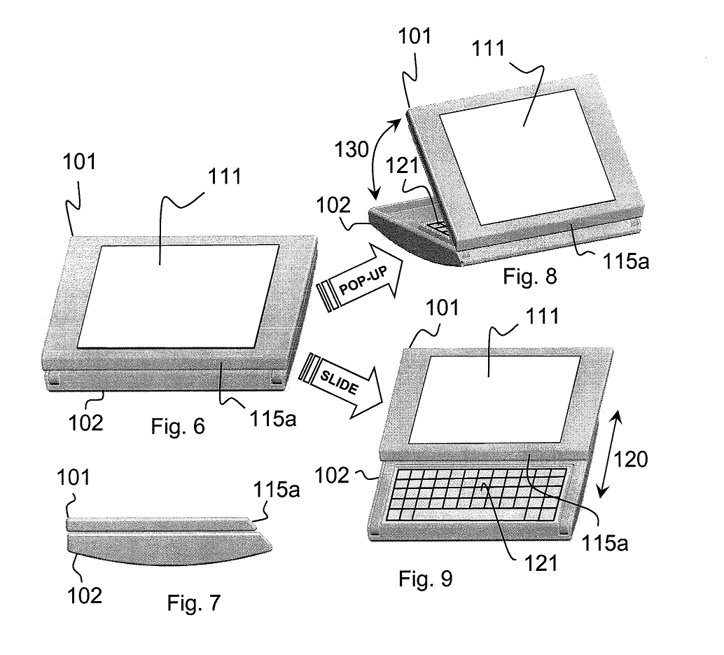

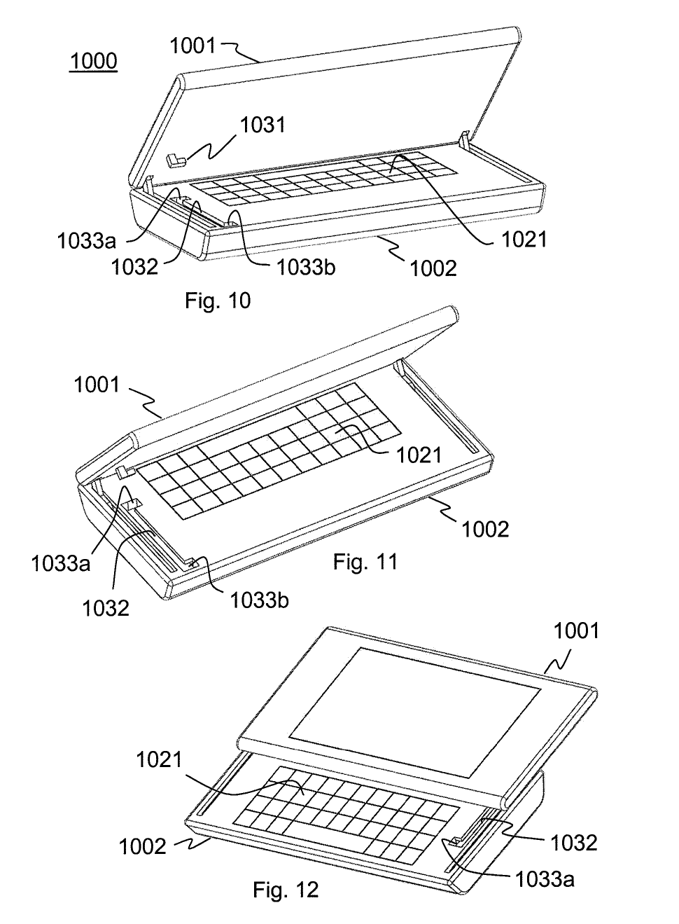

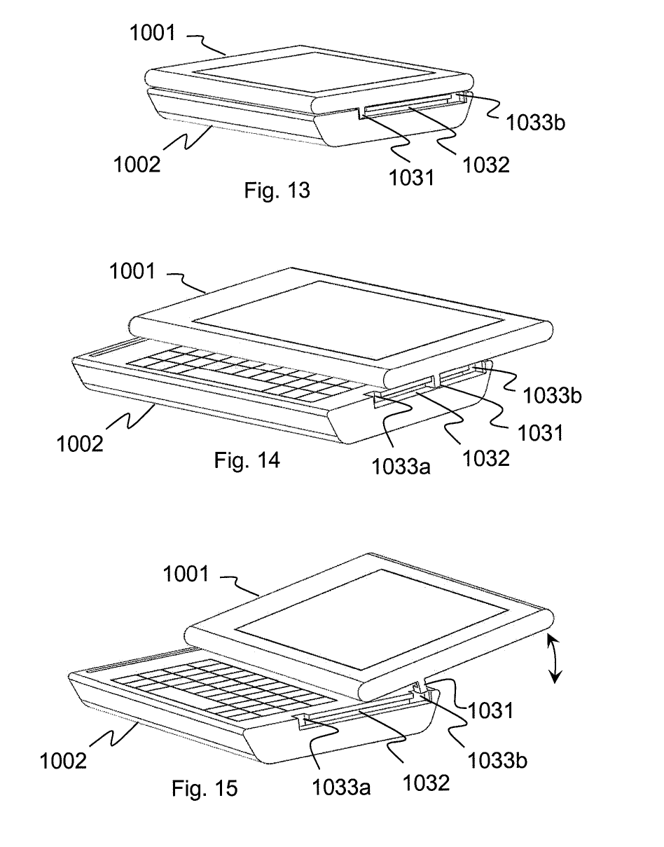

FIG. 6 shows another schematic drawing of an apparatus corresponding to the apparatus 100 in a closed configuration according to an example embodiment from a slightly different direction compared with the direction in FIG. 1.

FIG. 7 shows a specific detail of the apparatus of FIG. 6. In this example embodiment, the front end of the apparatus has an inclined form continuing from the front 115a of the top part 101 to the front end of the base part 102. In this way, the tilting of the top part 101 may be achieved more easily in some embodiments.

FIG. 8 shows a schematic drawing of the apparatus of FIG. 6 in the second open configuration and the tilting or pop-up function according to an example embodiment from a slightly different direction compared with the direction in FIG. 3. The apparatus may comprise a limiter (not shown) limiting the maximum tilting angle.

FIG. 9 shows a schematic drawing of the apparatus of FIG. 6 in the first open configuration and the side slide function according to an example embodiment from a slightly different direction compared with the direction in FIG. 2.

In certain example embodiments, the positions from which the top part can be tilted are controlled. The control can be achieved for example by having the top part and the base part to have such shapes (depending on the implementation) which allow tilting of the top part from certain positions only (for example, from the closed configuration only, or from the closed configuration and the first open configuration only). In certain example embodiments, the same effect can be achieved by having the joining part to prevent tilting from certain positions, for example from positions other than the fully closed configuration, or from positions other than the fully closed configuration and the first open configuration. Depending on the implementation, the hinge mechanism or similar of the joining part is, for example, locked so that rotating movement of the joint or hinge used (for example, the friction hinge) is prevented when the top part is in a position other than the position(s) from which tilting of the top part is allowed. In certain example embodiments an additional part (additional to the joining part) is used to control the positions from which the top part can be tilted.

Similarly, in certain example embodiments, the top part is prevented from sliding while in a tilted position. Depending on the implementation, the sliding can be prevented using corresponding ways, that is, by suitable design of the shapes of the top part and the base part and/or by suitable design of the joining part and/or via the use of an additional part.

FIG. 10 shows an example embodiment where an additional part is used to control the positions from which the top part can be tilted. The apparatus 1000 shown in FIG. 10 comprises a top part 1001 and a base part 1002. It otherwise basically corresponds to the apparatus 100 described in the foregoing, except that the apparatus 1000 further comprises a mechanism using a guide arm 1031, guide rail (or groove) 1032 and guide arm insertion slots 1033a, 1033b to prevent and allow tilting of the top part 1001 depending on the position of the slide at which the top part 1001 is located.

The mechanism shown in FIG. 10 is a single sided guide mechanism placed on the right side of the keypad 1021. Alternatively, the mechanism can be implemented on both sides of the keypad 1021. The guide arm 1031 is attached to the top part 1001, and it fits the guide rail 1032 located in the base part (bottom part) 1002. The guide arm 1031 and the guide rail may both comprise an L-shape profile. The two bigger openings/slots in both ends of the guide rail 1032 form the guide arm insertion slots 1033a, 1033b. The guide arm 1031 can enter and exit the guide rail 1032 only via these slots thereby disabling the possibility of tilting of the top part 1001 in any other mode than the closed configuration and the first open configuration.

FIG. 11 shows the apparatus of FIG. 10 from a slightly different projection.

FIG. 12 shows the sliding of the top part 1001 from the closed configuration to the first open configuration.

FIG. 13 shows a cross-sectional view of the apparatus 1000 in the closed configuration at the point of the guide rail 1032. The guide arm 1031 is at one end of the guide rail 1032 at the point of the guide arm insertion slot 1033a. Tilting of the top part 1001 from the closed configuration to the second open configuration is possible.

FIG. 14 shows another cross-sectional view of the apparatus 1000. The top part 1001 is in a mid-slide position, and the guide arm 1031 in the guide rail 1032 prevents the tilting of the top part 1001 from this position.

FIG. 15 shows a third open configuration to which the top part 1001 has been tilted from the first open configuration. In this third open configuration the apparatus 1000 provides tilting of the top part 1001 for adjusting the viewing angle while the keypad 1021 is visible (and usable). The guide arm 1031 has been slid into the other end of the guide rail 1032 at the point of the guide arm insertion slot 1033b. Tilting of the top part 1001 from the first open configuration to the third open configuration (as shown in FIG. 15) is possible.

The foregoing description has provided by way of non-limiting examples of particular implementations and embodiments of the invention a full and informative description of the best mode presently contemplated by the inventors for carrying out the invention. It is however clear to a person skilled in the art that the invention is not restricted to details of the embodiments presented above, but that it can be implemented in other embodiments using equivalent means or in different combinations of embodiments without deviating from the characteristics of the invention.

Furthermore, some of the features of the above-disclosed embodiments of this invention may be used to advantage without the corresponding use of other features. As such, the foregoing description shall be considered as merely illustrative of the principles of the present invention, and not in limitation thereof. Hence, the scope of the invention is only restricted by the appended patent claims.

1. An apparatus comprising:
a first part;
a second part; and
a joining part configured to join together the first part with the second part, wherein the joining part is configured to allow:
(i) sliding of the second part in relation to the first part from a closed configuration to a first open configuration, and
(ii) tilting of the second part in relation to the first part from the closed configuration to a second open configuration.

2. An apparatus according to claim 1, wherein the first part has a first user interface element which is revealed upon sliding the second part in relation to the first part from the closed configuration to the first open configuration.

3. An apparatus according to claim 2, wherein the first user interface element is a keyboard.

4. An apparatus according to claim 1, wherein the second part has a display.

5. An apparatus according to claim 1, wherein the first part and the second part are completely against each other in the closed configuration, partly against each other in the first open configuration and in an angled position against each other in the second open configuration.

6. An apparatus according to claim 1, wherein the joining part is configured to allow:
tilting up the second part without having to slide the second part in relation to the first part first.

7. An apparatus according to claim 1, wherein the apparatus is configured to allow lifting the second part from a back end of the second part wherein the second part rotates around a rotation axis substantially formed by its front end.

8. An apparatus according to claim 1, wherein the tilting into the second open configuration occurs by the second part tilting and the front end of the second part substantially keeping its lateral location in the same place as it was in the closed configuration.

9. An apparatus according to claim 1, wherein the joining part is configured to provide a side slide function for the apparatus, and separately, tilting up function via jointed movement of the second part.

10. An apparatus according to claim 1, wherein the joining part comprises a hinge mechanism allowing rotation of the second part.

11. An apparatus according to claim 10, wherein the hinge mechanism comprises a friction hinge.

12. An apparatus according to claim 10, wherein the joining part comprising the hinge mechanism is configured to slide in a groove comprised by the first part.

13. An apparatus according to claim 1, wherein the apparatus is configured to open like a book from the closed configuration to the second open configuration.

14. An apparatus according to claim 1, wherein the movement from the closed configuration to the first open configuration is substantially a planar movement.

15. An apparatus according to claim 1, wherein the tilting angle into which the second part settles is adjustable to the user.

16. An apparatus according to claim 1, comprising a control mechanism configured to prevent tilting of the second part in relation to the first part from other positions than the closed configuration.

17. An apparatus according to claim 1, comprising a control mechanism configured to allow:
(iii) tilting of the second part in relation to the first part from the first open configuration to a third open configuration, and wherein the control mechanism is configured to prevent:
(iv) tilting of the second part in relation to the first part from other positions than the closed configuration and the first open configuration.

18. An apparatus according to claim 1, wherein the apparatus is a mobile handheld communication device.

19. An apparatus comprising:
a first part;
a second part; and
means for joining together the first part with the second part, wherein said means are configured to allow:
(i) sliding of the second part in relation to the first part from a closed configuration to a first open configuration, and
(ii) tilting of the second part in relation to the first part from the closed configuration to a second open configuration.

20. An apparatus comprising:
a joining part configured to join together a first part and a second part of a device, wherein the joining part is configured to allow:
(i) sliding of the second part in relation to the first part from a closed configuration to a first open configuration, and
(ii) tilting of the second part in relation to the first part from the closed configuration to a second open configuration.
